(19) United States
(12) Patent Application Publication
(10) Pub. No.: US 2011/0155958 A1
(43) Pub. Date: Jun. 30, 2011

(54) METHODS AND APPARATUS FOR DRYING AND GASIFICATION OF BIOMASS

(75) Inventors: John D. WINTER, Broomfield, CO (US); Curtis J. Jacks, Superior, CO (US); Shakeel H. Tirmizi, Matawan, NJ (US)

(73) Assignee: Range Fuels, Inc., Broomfield, CO (US)

(21) Appl. No.: 12/980,317

(22) Filed: Dec. 28, 2010

Related U.S. Application Data
(60) Provisional application No. 61/291,484, filed on Dec. 31, 2009.
(60) Provisional application No. 61/291,502, filed on Dec. 31, 2009.

(51) Int. Cl. C01B 3/02; F26B 17/10

(52) U.S. Cl. 252/373; 34/582

(57) ABSTRACT

In some variations, this invention provides a method of drying and gasifying a carbon-containing feedstock, comprising combusting methane to generate heat and a flue gas; drying the carbon-containing feedstock using part of the flue gas; and gasifying the dried feedstock to generate syngas. Some embodiments provide an apparatus for drying comprising a vessel; a primary channel for flowing the solid feedstock and a gas for drying the solid feedstock; a secondary channel for flowing the gas; and a plurality of internal screens or sieve plates suitable for passage of the gas. Other variations provide an apparatus including a primary vessel having a channel for axially flowing the solid feedstock; a pipe contained within the primary vessel, with a plurality of openings for radially distributing a gas for drying the solid feedstock; and a plurality of exit ports at the walls for removal of the gas from the primary vessel.

### PRIORITY DATA

This patent application claims priority under 35 U.S.C. §120 from U.S. Provisional Patent Application Nos. 61/291,484 and 61/291,502, each filed Dec. 31, 2009, the disclosures of which are hereby incorporated by reference herein for all purposes.

### FIELD OF THE INVENTION

The present invention generally relates to processes for the drying and conversion of biomass and other carbonaceous materials into synthesis gas.

### BACKGROUND OF THE INVENTION

Synthesis gas, which is also known as syngas, is a mixture of gases comprising carbon monoxide (CO) and hydrogen (H₂). Syngas is a platform intermediate in the chemical and biorefining industries. Syngas can be converted into alkanes, olefins, oxygenates, and alcohols such as ethanol. These chemicals can be blended into, or used directly as, diesel fuel, gasoline, and other liquid fuels. Syngas can also be directly combusted to produce heat and power.

Generally, syngas may be produced from any carbonaceous material. In particular, biomass such as agricultural wastes, forest products, grasses, and other cellulosic material may be converted to syngas. Biomass typically includes substantial moisture when it is harvested or collected. Generally, the feedstock moisture content should be reduced before the biomass is fed to a process for conversion to syngas. Lower moisture improves process efficiency and reduces energy requirements and emissions.

There are several known methods for drying biomass. For example, see Amos, “Report on Biomass Drying Technology,” National Renewable Energy Laboratory, TP-570-25885, November 1998, which is incorporated by reference herein.

In view of what is known in the art, what are currently needed are improved methods and apparatus for drying biomass. In the context of gasification methods for converting biomass to syngas, there is a need for process configurations that economically optimize both drying and gasification, and in some embodiments, combine at least part of each of drying and gasification into a single step.

### SUMMARY OF THE INVENTION

In some variations, this invention provides a method of drying and gasifying a carbon-containing feedstock, the method comprising:
(a) combusting a fuel comprising methane to generate heat and a flue gas;
(b) drying the carbon-containing feedstock, at least in part, using at least a portion of the flue gas, thereby generating a dried feedstock;
(c) gasifying the dried feedstock to generate a gas stream comprising syngas, wherein the gasifying includes introducing at least some of the heat from step (a).

In some embodiments, the carbon-containing feedstock is selected from the group consisting of timber harvesting residues, softwood chips, hardwood chips, tree branches, tree stumps, leaves, bark, sawdust, paper pulp, corn stover, wheat straw, rice straw, sugarcane bagasse, switchgrass, miscanthus, animal manure, municipal solid waste, municipal sewage, commercial waste, used tires, grape pumice, almond shells, pecan shells, coconut shells, coffee grounds, grass pellets, hay pellets, wood pellets, cardboard, paper, plastic, rubber, cloth, coal, lignite, coke, lignin, petroleum, and any combinations thereof.

Dried feedstock, after conducting step (b), can contain 25 wt % or less moisture, and in some embodiments will contain 10-15 wt % or less moisture.

In some embodiments, at least some of the methane combusted in step (a) is derived from gasifying the feedstock.

The drying in step (b) can include direct heating of the feedstock by the flue gas. In some embodiments, the flue gas directly contacts the feedstock contained in a vessel. In other embodiments, the flue gas directly contacts the feedstock contained in a pile. Optionally, or additionally, the flue gas directly contacts the feedstock while the feedstock is being transported or conveyed.

The drying in step (b) can include indirect heating of the feedstock by the flue gas. In some embodiments, the flue gas indirectly heats the feedstock contained in a vessel or in a pile. Optionally, or additionally, the flue gas indirectly heats the feedstock while the feedstock is being transported or conveyed.

In certain embodiments, step (b) comprises introducing the flue gas into an inner pipe within a vessel, wherein the feedstock is contained in an annulus between the inner pipe and the vessel wall. In other embodiments, step (b) comprises introducing the flue gas into an outer annulus within a vessel, wherein the feedstock is contained in an inner pipe in the vessel. In either of these embodiments, the annulus can include holes or sieves for distribution of the flue gas in a manner suitable for direct heating of the feedstock within the vessel.

The flue gas and the feedstock can be in cocurrent contact, countercurrent contact, or some combination of the two flow patterns.

In some embodiments, a separate drying step is carried out prior to step (b) to generate the carbon-containing feedstock. Steps (b) and (c) can be at least partially combined in space and/or time, if desired.

Some embodiments employ a flue gas having at least one sulfur compound effective for pretreatment of the feedstock to enhance the gasification.

Along with drying (removing water), certain organic molecules can be recovered. For example, pinenes and/or turpenes can be recovered if desired. Some specific molecules that can be recovered are α-pinene, β-pinene, formaldehyde, and methanol. The recovery optionally employs molecular sieves.

Other variations of the invention provide an apparatus for drying a carbon-containing solid feedstock, the apparatus comprising: a vessel; a primary channel for flowing the solid feedstock and a gas for drying the solid feedstock; a secondary channel for flowing the gas; and a plurality of internal screens or sieve plates in communication with the primary channel and the secondary channel, wherein the internal screens or sieve plates are suitable for passage of the gas but not for substantial passage of the solid feedstock.

In some embodiments, the internal screens or sieve plates are disposed with the vessel wall at an angle different from 90 degrees. The primary channel optionally has a varying diameter along a length of the vessel. Some embodiments include a primary channel with a minimum diameter that is less than one-half, or less than one-fourth, the diameter of the vessel.

Generally, the apparatus can be configured to carry out the methods disclosed herein.

In still other variations of the present invention, an apparatus is provided for drying a carbon-containing solid feedstock, the apparatus comprising: a primary vessel having a channel for axially flowing the solid feedstock; a secondary vessel, contained within the primary vessel, with a plurality of openings for radially distributing a gas for drying the solid feedstock; and a plurality of exit ports at the walls of the primary vessel for removal of the gas from the primary vessel.

The primary vessel is preferably, but not necessarily, a vertical unit. The secondary vessel can be a pipe at or near the axial centerline of the primary vessel. A collection header can be connected to the primary vessel.

Preferably, the apparatus is a multiple-effect dryer. Multiple effects arise due to the plurality of openings in the secondary vessel and the plurality of exit ports in the primary vessel, according to some embodiments. Multiple effects can also arise due to radially distributed gas contact with an axially flowing solid stream, according to preferred embodiments of this variation of the invention.

The plurality of exit ports can be spaced apart with a spacing length of less than or about one primary-vessel diameter. In some embodiments, the exit ports are spaced apart with a spacing length of less than or about one secondary-vessel diameter (which is smaller than the primary-vessel diameter). In certain embodiments, the exit ports are spaced apart with a spacing length that is between the primary-vessel diameter and the secondary-vessel diameter.

The primary vessel can be configured with an outlet conical region suitable for continuous passage of dried solid feedstock, which is a practical benefit. The conical region, in various embodiments, has a cone angle greater than about 20, 30, or 45 degrees.

In yet another variation, an apparatus for drying a carbon-containing solid feedstock is provided, the apparatus comprising: a primary vessel having a channel for axially flowing the solid feedstock; a plurality of inlet ports at the walls of the primary vessel for introduction of a gas for drying the solid feedstock into the primary vessel; and a secondary vessel, contained within the primary vessel, with a plurality of openings for receiving the gas.

The secondary vessel can be a pipe at or near the axial centerline of the primary vessel. The apparatus can operate as a multiple-effect dryer.

The plurality of inlet ports can be spaced apart with a spacing length of less than or about one primary-vessel diameter. In some embodiments, the inlet ports are spaced apart with a spacing length of less than or about one secondary-vessel diameter. In other embodiments, the inlet ports are spaced apart with a spacing length that is between the primary-vessel diameter and the secondary-vessel diameter.

The primary vessel can include an outlet conical region suitable for continuous passage of dried solid feedstock. This conical region can include a cone angle greater than about 20 degrees, such as 30-45 degrees or more.

In other variations, methods are provided for drying feedstocks using the above-described apparatus. In some variations, a method of drying a carbon-containing solid feedstock comprises the steps of:
(a) providing a carbon-containing solid feedstock containing moisture;
(b) introducing the solid feedstock into a primary vessel having a channel for axially flowing the solid feedstock;
(c) introducing a gas for drying the solid feedstock into a secondary vessel, contained within the primary vessel, wherein the secondary vessel includes a plurality of openings that radially distribute the gas into the primary vessel; and
(d) removing the gas and at least a portion of the moisture through a plurality of exit ports at the walls of the primary vessel.

In some embodiments, the carbon-containing feedstock is selected from the group consisting of timber harvesting residues, softwood chips, hardwood chips, tree branches, tree stumps, leaves, bark, sawdust, paper pulp, corn stover, wheat straw, rice straw, sugarcane bagasse, switchgrass, miscanthus, animal manure, municipal solid waste, municipal sewage, commercial waste, used tires, grape pumice, almond shells, pecan shells, coconut shells, coffee grounds, grass pellets, hay pellets, wood pellets, cardboard, paper, plastic, rubber, cloth, coal, lignite, coke, lignin, petroleum, and any combinations thereof.

The gas for drying (e.g., CO₂, N₂, air, etc.) can be introduced into the secondary vessel cocurrently with the solid feedstock into the primary vessel. In other embodiments, the gas is introduced into the secondary vessel countercurrently with the solid feedstock into the primary vessel.

The secondary vessel can be a pipe at or near the axial centerline of the primary vessel. The gas is preferably distributed from the secondary vessel into the primary vessel in substantially the radial dimension and substantially perpendicular to the direction of flow of the solid feedstock. Multiple-effect drying can be realized.

In other variations, a method of drying a carbon-containing solid feedstock is provided, the method comprising:
(a) providing a carbon-containing solid feedstock containing moisture;
(b) introducing the solid feedstock into a primary vessel having a channel for axially flowing the solid feedstock;
(c) introducing a gas for drying the solid feedstock into a plurality of inlet ports at the walls of the primary vessel; and
(d) removing the gas and at least a portion of the moisture through a plurality of openings in a secondary vessel contained in the primary vessel.

The gas for drying is preferably distributed from the secondary vessel into the primary vessel in substantially the radial dimension and substantially perpendicular to the direction of flow of the solid feedstock.

In embodiments wherein syngas is a desired product from dried biomass, these methods further include gasifying dried solid feedstock to generate a gas stream comprising syngas.

### BRIEF DESCRIPTION OF THE FIGURES

FIG. 1 is a sketch of an apparatus according to some non-limiting embodiments of the present invention.

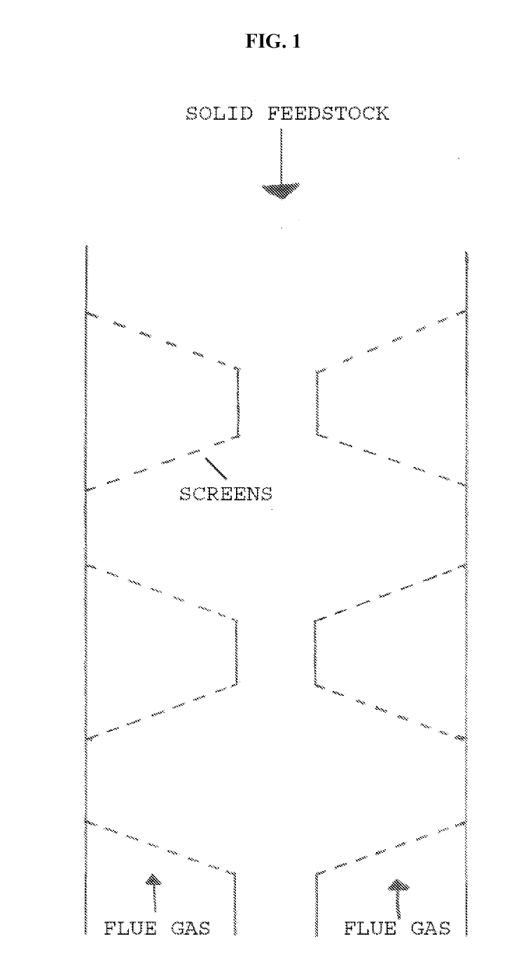

FIG. 2 is a sketch of an apparatus according to some non-limiting embodiments of the present invention.

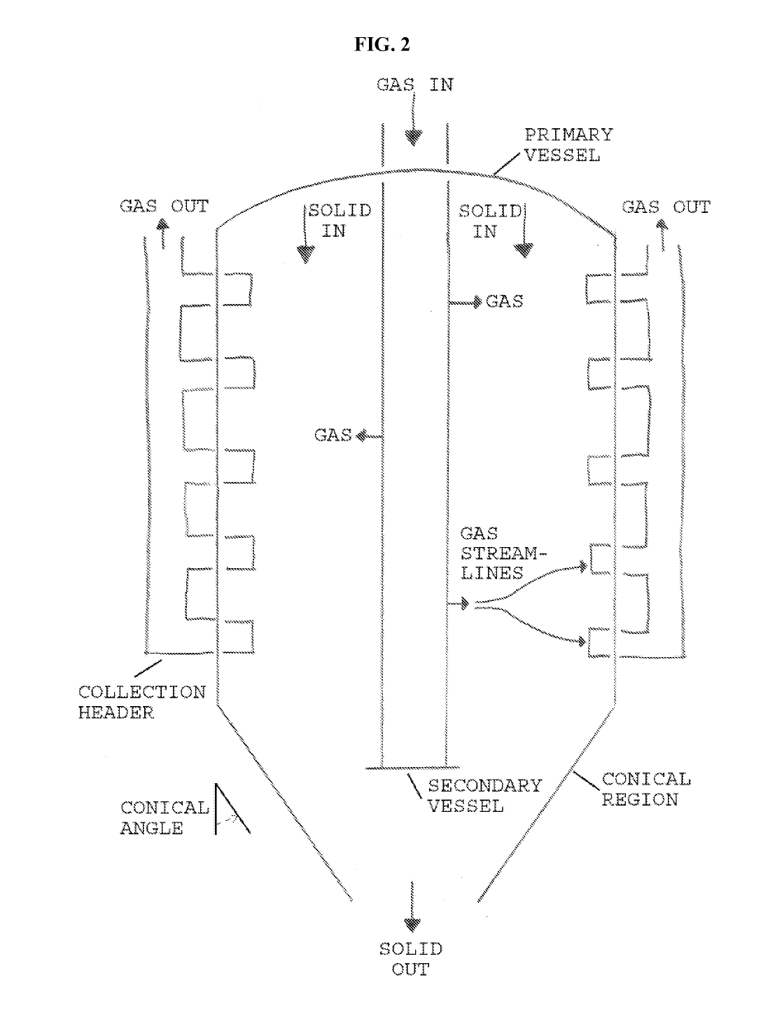

These and other embodiments, features, and advantages of the present invention will become more apparent to those skilled in the art when taken with reference to the following detailed description of the invention.

### DETAILED DESCRIPTION OF EMBODIMENTS OF THE INVENTION

Certain embodiments of the present invention will now be further described in more detail, in a manner that enables the claimed invention so that a person of ordinary skill in this art can make and use the present invention.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that may vary depending at least upon the specific analytical technique. Any numerical value inherently contains certain errors necessarily resulting from the standard deviation found in its respective testing measurements.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. If a definition set forth in this section is contrary to or otherwise inconsistent with a definition set forth in patents, published patent applications, and other publications that are herein incorporated by reference, the definition set forth in this specification prevails over the definition that is incorporated herein by reference.

In some variations, this invention provides a method of drying and gasifying a carbon-containing feedstock, the method comprising:
(a) combusting a fuel comprising methane to generate heat and a flue gas;
(b) drying the carbon-containing feedstock, at least in part, using at least a portion of the flue gas, thereby generating a dried feedstock; and
(c) gasifying the dried feedstock to generate a gas stream comprising syngas, wherein the gasifying includes introducing at least some of the heat from step (a).

In some embodiments, the carbon-containing feedstock is selected from the group consisting of timber harvesting residues, softwood chips, hardwood chips, tree branches, tree stumps, leaves, bark, sawdust, paper pulp, corn stover, wheat straw, rice straw, sugarcane bagasse, switchgrass, miscanthus, animal manure, municipal solid waste, municipal sewage, commercial waste, used tires, grape pumice, almond shells, pecan shells, coconut shells, coffee grounds, grass pellets, hay pellets, wood pellets, cardboard, paper, plastic, rubber, cloth, coal, lignite, coke, lignin, petroleum, and any combinations thereof.

Dried feedstock, after conducting step (b), can contain 25 wt % or less moisture, and in some embodiments will contain 10-15 wt % or less moisture. It will be appreciated that process control can be implemented to achieve a desired level of drying. For example, moisture levels in the solid material introduced to step (c) can be measured by known techniques, or water content in the flue gas after contacting the feedstock in step (b) can be measured. The desired moisture level can be adjusted in view of downstream considerations and for economic reasons.

Certain embodiments employ closed-loop dryers with reuse of water vapor (removed from the feedstock) as a low-level heat source elsewhere in the overall process.

In some embodiments, at least some of the methane combusted in step (a) is derived from gasifying the feedstock. That is, gasification produces CO, H₂, and CO₂ but also various quantities of CH₄. This methane can be used for a variety of process purposes but one possibility is to recycle and burn some or all of it in step (a).

The drying in step (b) can include direct heating of the feedstock by the flue gas. In some embodiments, the flue gas directly contacts the feedstock contained in a vessel (which includes closed vessels, storage bins, silos, and the like). In other embodiments, the flue gas directly contacts the feedstock contained in a pile (which includes open piles, bales, laid-down feedstock, and the like). Optionally, or additionally, the flue gas directly contacts the feedstock while the feedstock is being transported or conveyed using known means.

The drying in step (b) can include indirect heating of the feedstock by the flue gas. In some embodiments, the flue gas indirectly heats the feedstock contained in a vessel or in a pile. Optionally, or additionally, the flue gas indirectly heats the feedstock while the feedstock is being transported or conveyed. It is also possible to combine some amount of indirect heating with some amount of direct heating, of course.

In certain embodiments, step (b) comprises introducing the flue gas into an inner pipe within a vessel, wherein the feedstock is contained in an annulus between the inner pipe and the vessel wall. In other embodiments, step (b) comprises introducing the flue gas into an outer annulus within a vessel, wherein the feedstock is contained in an inner pipe in the vessel. In either of these embodiments, the annulus can include holes or sieves for distribution of the flue gas in a manner suitable for direct heating of the feedstock within the vessel.

The flue gas and the feedstock can be in cocurrent contact, countercurrent contact, or some combination of the two flow patterns. Countercurrent flow typically provides more-efficient heat transfer.

In some embodiments, a separate drying step is carried out prior to step (b) to generate the carbon-containing feedstock. For example, bulk drying could be accomplished separately, before introducing partially dried material to the process or apparatus of the present invention. Open drying (e.g., in a field) can be first carried out in some embodiments. Naturally, some amount of drying is expected to occur while biomass is stored, depending on environmental conditions (humidity, temperature, etc.).

Steps (b) and (c) can be at least partially combined in space and/or time, if desired. That is, drying and gasification can overlap which may or may not be desired. On the one hand, gasification equipment may not be the best use of capital for drying. On the other hand, reduction in number or process steps and units is generally an economically attractive benefit in process engineering. Removing water and then later adding it (for devolatilization and/or steam reforming) may not be optimal.

Technically, it will be realized that it may be difficult to completely separate the drying and gasification functions in any system. As water turns into steam and is removed from the bulk material, the exit path of the water molecule will almost certainly cause collisions with other carbonaceous material which can lead to devolatilization and steam reforming chemistry. It is hypothesized in the art that steam traversal may open the pores of the cellulose structure and render devolatilization more efficient.

Combined drying and gasification, if it is desired, will need to consider how to rectify the fact that the optimal drying conditions (temperature, pressure, gas for drying, residence time, etc.) will be different than the optimal gasification conditions. For example, the gasification temperature will be higher than the drying temperature. It is possible to employ multiple stages in a single unit, or multiple units in a system, to accomplish integrated drying and gasification.

Some embodiments employ a flue gas having at least one sulfur compound effective for pretreatment of the feedstock to enhance the gasification. This sulfur compound can be, for example, H₂5, SO₂, COS, or CS₂. The source of the sulfur compound(s) can be elsewhere within the process, or from any other source.

Along with drying (removing water), certain organic molecules can be recovered. For example, pinenes and/or turpenes can be separated and recovered if desired. Some specific molecules that can be recovered are α-pinene, β-pinene, formaldehyde, and methanol. The recovery optionally employs molecular sieves such as classes 3A, 4A, and 13X.

When softwood is employed as the carbon-containing feedstock, pinenes are expected to evolve during all stages of drying. The “surface pinene” (which causes the scent in fresh wood) will evolve even at low drying temperatures and can be captured in carbon beds. Pine oil, containing α-pinene, β-pinene, and small quantities of mono-terpenes, formaldehyde, and methanol, can be recovered if desired. Staged molecular-sieve beds could additionally remove sulfur compounds, for example in the upstream bed; followed by removal of pine oil components in downstream beds.

Other variations of the invention provide an apparatus for drying a carbon-containing solid feedstock, the apparatus comprising: a vessel; a primary channel for flowing the solid feedstock and a gas for drying the solid feedstock; a secondary channel for flowing the gas; and a plurality of internal screens or sieve plates in communication with the primary channel and the secondary channel, wherein the internal screens or sieve plates are suitable for passage of the gas but not for substantial passage of the solid feedstock.

In some embodiments, the internal screens or sieve plates are disposed with the vessel wall at an angle different from 90 degrees. The primary channel optionally has a varying diameter along a length of the vessel. Some embodiments include a primary channel with a minimum diameter that is less than one-half, or less than one-fourth, the diameter of the vessel.

In still other variations of the present invention, an apparatus is provided for drying a carbon-containing solid feedstock, the apparatus comprising: a primary vessel having a channel for axially flowing the solid feedstock; a secondary vessel, contained within the primary vessel, with a plurality of openings for radially distributing a gas for drying the solid feedstock; and a plurality of exit ports at the walls of the primary vessel for removal of the gas from the primary vessel.

The primary vessel is preferably, but not necessarily, a vertical unit. The secondary vessel can be a pipe at or near the axial centerline of the primary vessel. A collection header can be connected to the primary vessel for receiving gas.

Preferably, the apparatus is a multiple-effect dryer. Multiple effects arise due to the plurality of openings in the secondary vessel and the plurality of exit ports in the primary vessel, according to some embodiments. Multiple effects can also arise due to radially distributed gas contact with an axially flowing solid stream.

The plurality of exit ports can be spaced apart with a spacing length of less than or about one primary-vessel diameter. In some embodiments, the exit ports are spaced apart with a spacing length of less than or about one secondary-vessel diameter (which is smaller than the primary-vessel diameter). In certain embodiments, the exit ports are spaced apart with a spacing length that is between the primary-vessel diameter and the secondary-vessel diameter.

The primary vessel can be configured with an outlet conical region suitable for continuous passage of dried solid feedstock, which is a practical benefit. The conical region, in various embodiments, has a cone angle greater than about 20, 30, or 45 degrees.

In yet another variation, an apparatus for drying a carbon-containing solid feedstock is provided, the apparatus comprising: a primary vessel having a channel for axially flowing the solid feedstock; a plurality of inlet ports at the walls of the primary vessel for introduction of a gas for drying the solid feedstock into the primary vessel; and a secondary vessel, contained within the primary vessel, with a plurality of openings for receiving the gas.

The secondary vessel can be a pipe at or near the axial centerline of the primary vessel. The apparatus can operate as a multiple-effect dryer.

The plurality of inlet ports can be spaced apart with a spacing length of less than or about one primary-vessel diameter. In some embodiments, the inlet ports are spaced apart with a spacing length of less than or about one secondary-vessel diameter. In other embodiments, the inlet ports are spaced apart with a spacing length that is between the primary-vessel diameter and the secondary-vessel diameter.

The primary vessel can include an outlet conical region suitable for continuous passage of dried solid feedstock. This conical region can include a cone angle greater than about 20 degrees, such as 30-45 degrees or more.

In other variations, methods are provided for drying feedstocks using the above-described apparatus. In some variations, a method of drying a carbon-containing solid feedstock comprises the steps of:
(a) providing a carbon-containing solid feedstock containing moisture;
(b) introducing the solid feedstock into a primary vessel having a channel for axially flowing the solid feedstock;
(c) introducing a gas for drying the solid feedstock into a secondary vessel, contained within the primary vessel, wherein the secondary vessel includes a plurality of openings that radially distribute the gas into the primary vessel; and
(d) removing the gas and at least a portion of the moisture through a plurality of exit ports at the walls of the primary vessel.

In some embodiments, the carbon-containing feedstock is selected from the group consisting of timber harvesting residues, softwood chips, hardwood chips, tree branches, tree stumps, leaves, bark, sawdust, paper pulp, corn stover, wheat straw, rice straw, sugarcane bagasse, switchgrass, miscanthus, animal manure, municipal solid waste, municipal sewage, commercial waste, used tires, grape pumice, almond shells, pecan shells, coconut shells, coffee grounds, grass pellets, hay pellets, wood pellets, cardboard, paper, plastic, rubber, cloth, coal, lignite, coke, lignin, petroleum, and any combinations thereof.

The gas for drying (e.g., CO₂, N₂, air, etc.) can be introduced into the secondary vessel cocurrently with the solid feedstock into the primary vessel. In other embodiments, the gas is introduced into the secondary vessel countercurrently with the solid feedstock into the primary vessel.

The secondary vessel can be a pipe at or near the axial centerline of the primary vessel. The gas is preferably distributed from the secondary vessel into the primary vessel in substantially the radial dimension and substantially perpendicular to the direction of flow of the solid feedstock. Multiple-effect drying can be realized.

In other variations, a method of drying a carbon-containing solid feedstock is provided, the method comprising:
(a) providing a carbon-containing solid feedstock containing moisture;
(b) introducing the solid feedstock into a primary vessel having a channel for axially flowing the solid feedstock;
(c) introducing a gas for drying the solid feedstock into a plurality of inlet ports at the walls of the primary vessel; and
(d) removing the gas and at least a portion of the moisture through a plurality of openings in a secondary vessel contained in the primary vessel.

The gas for drying is preferably distributed from the secondary vessel into the primary vessel in substantially the radial dimension and substantially perpendicular to the direction of flow of the solid feedstock. Of course, the gas flow will not be perfectly radial or perpendicular to the direction of solid flow, at least because of the effects of diffusion and dispersion of flow profiles. Also, a gas molecule that is introduced from the secondary vessel will initially be flowing in substantially the radial dimension but will likely need to traverse to some extent in the axial direction, depending on the specific locations of outlet ports.

In one specific variation, a flue gas passes cocurrently with the wet wood down a vertical pipe. The feedstock falls by gravity. A continuous screw or auger is employed, wherein the screw does not have a central shaft and does not rotate. The flights are wider than the internal radius of the pipe. The pitch will be dictated by what is needed to for feedstock hold-up and residence time on each flight. The flights are perforated to allow direct contact with the flue gas, preferably smaller than the smallest expected feedstock particle size to minimize plugging. In some embodiments, the auger flights are not directly welded to the inside wall of the pipe, thereby allowing pulsing vibrations to prevent stagnant zones or bypassing channels, and to insure that the feedstock continues to flow down the flights. Optionally, a few degrees of rotational movement in a fixed arc can be included. Support rods can be included in the axial direction of the flights.

In embodiments wherein syngas is a desired product from dried biomass, these methods further include gasifying dried solid feedstock to generate a gas stream comprising syngas. Syngas can be produced from dried biomass (or other carbon-containing feedstocks) by any known means, such as by one or more of gasification, pyrolysis, devolatilization, steam reforming, and partial oxidation of one or more feedstocks recited herein. In some embodiments, syngas is produced by the methods taught in U.S. patent application Ser. No. 12/166,167, entitled “METHODS AND APPARATUS FOR PRODUCING SYNGAS,” filed Jul. 1, 2008, whose assignee is the same as the assignee of this patent application, and which is hereby incorporated herein by reference.

Engineering optimization can be conducted to achieve energy integration. For example, energy requirements can be reduced by combining portions of streams from individual processes into a single unit. Various levels of heat recovery can be employed to meet drying and gasification requirements.

All publications, patents, and patent applications cited in this specification are incorporated herein by reference in their entirety as if each publication, patent, or patent application was specifically and individually put forth herein.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent that there are variations of the invention, which are within the spirit of the disclosure or equivalent to the inventions found in the appended claims, it is the intent that this patent will cover those variations as well. The present invention shall only be limited by what is claimed.

What is claimed is:

1. A method of drying and gasifying a carbon-containing feedstock, said method comprising:
(a) combusting a fuel comprising methane to generate heat and a flue gas;
(b) drying said carbon-containing feedstock, at least in part, using at least a portion of said flue gas, thereby generating a dried feedstock;
(c) gasifying said dried feedstock to generate a gas stream comprising syngas, wherein said gasifying includes introducing at least some of said heat from step (a).

2. The method of claim 1, wherein at least some of said methane combusted in step (a) is derived from gasifying said feedstock.

3. The method of claim 1, wherein said drying in step (b) includes direct heating of said feedstock by said flue gas.

4. The method of claim 3, wherein said flue gas directly contacts said feedstock while said feedstock is being transported or conveyed.

5. The method of claim 1, wherein step (b) comprises introducing said flue gas into an inner pipe within a vessel, wherein said feedstock is contained in an annulus between said inner pipe and a vessel wall, and wherein said annulus includes holes or sieves for distribution of said flue gas in a manner suitable for direct heating of said feedstock.

6. The method of claim 1, wherein step (b) comprises introducing said flue gas into an outer annulus within a vessel, wherein said feedstock is contained in an inner pipe in said vessel, and wherein said annulus includes holes or sieves for distribution of said flue gas in a manner suitable for direct heating of said feedstock.

7. The method of claim 1, further comprising a separate drying step prior to step (b) to generate said carbon-containing feedstock.

8. The method of claim 1, wherein steps (b) and (c) are at least partially combined in space and time.

9. The method of claim 1, wherein said flue gas includes at least one sulfur compound effective for pretreatment of said feedstock to enhance said gasification.

10. The method of claim 1, further comprising recovery of one or more compounds selected from the group consisting of α-pinene, β-pinene, a terpene, formaldehyde, and methanol.

11. An apparatus for drying a carbon-containing solid feedstock, said apparatus comprising: a vessel; a primary channel for flowing said solid feedstock and a gas for drying said solid feedstock; a secondary channel for flowing said gas; and a plurality of internal screens or sieve plates in communication with said primary channel and said secondary channel, wherein said internal screens or sieve plates are suitable for passage of said gas but not for substantial passage of said solid feedstock.

12. The apparatus of claim 11, wherein said internal screens or sieve plates are disposed with said vessel wall at an angle different from 90 degrees.

13. The apparatus of claim 11, wherein said primary channel has a varying diameter along a length of said vessel.

14. The apparatus of claim 13, wherein said primary channel has a minimum diameter that is less than one-half the diameter of said vessel.

15. An apparatus for drying a carbon-containing solid feedstock, said apparatus comprising: a primary vessel having a channel for axially flowing said solid feedstock; a secondary vessel, contained within said primary vessel, with a plurality of openings for radially distributing a gas for drying said solid feedstock; and a plurality of exit ports at the walls of said primary vessel for removal of said gas from said primary vessel.

16. The apparatus of claim 15, wherein said secondary vessel is a pipe at or near the axial centerline of said primary vessel.

17. The apparatus of claim 15, further comprising a collection header connected to said primary vessel.

18. The apparatus of claim 15, wherein said plurality of exit ports are spaced apart with a spacing length of less than one primary-vessel diameter.

19. The apparatus of claim 15, wherein said plurality of exit ports are spaced apart with a spacing length of less than one secondary-vessel diameter.

20. The apparatus of claim 15, wherein said primary vessel comprises an outlet conical region suitable for continuous passage of dried solid feedstock.
